(19) United States
(12) Patent Application Publication
(10) Pub. No.: US 2010/0290454 A1
(43) Pub. Date: Nov. 18, 2010

(54) Play-Out Delay Estimation

(75) Inventor: Jonas Lundberg, Lulea (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/745,051

(22) PCT Filed: Sep. 9, 2008
(86) PCT No.: PCT/SE08/51003

§ 371 Date: May 27, 2010

Related U.S. Application Data
(60) Provisional application No. 60/991,336, filed on Nov. 30, 2007.

(51) Int. Cl. H04L 12/66

(52) U.S. Cl. 370/352

(57) ABSTRACT

A receiving terminal estimates a required jitter buffer depth for each received audio frame, by locating (61) the fastest previously received audio frame, calculating (62) an estimated required play-out delay from stored data associated with said fastest audio frame, and transforming (63) the estimated play-out delay into a required jitter buffer depth for accommodating the calculated play-out delay of the received audio frame. Further, this required jitter buffer depth is made available for jitter buffer management, e.g. to achieve a certain loss rate. Data associated with each received audio frame is stored to be used for estimating the required jitter buffer depth for consecutive audio frames.

### TECHNICAL FIELD

The present invention relates to a method in a receiving terminal of estimating a required jitter buffer depth, a method in a receiving terminal of jitter buffer management, as well as a receiving terminal.

### BACKGROUND

In e.g. IP (Internet Protocol)-telephony, voice samples are forwarded from a sending terminal to a receiving terminal, and the latency, or delay, of the connection defines the time it takes for a data packet to be transported between the sending terminal and the receiving terminal. The packets are stored temporarily in buffers in the nodes of a packet switched network, and the varying storage time in the buffers leads to variations in the delay, which is referred to as a delay jitter. While a circuit switched network normally is designed to minimize the jitter, a packet switched network is designed to maximize the link utilization by queuing the packets in the buffers for subsequent transmission, which will add to the delay jitter.

A protocol used to carry voice signals over the IP network is commonly referred to as a VoIP (Voice over Internet Protocol), allowing a unified network to be used for multiple services. An incoming IP-phone call may be automatically routed to an IP-phone located anywhere, and thereby a user is allowed to make and receive phone calls using the same phone number during travelling, regardless of location. However, VoIP involves drawbacks, such as delay, packet loss and the above-described delay jitter. The delay jitter may lead to buffer underrun, when a play-out buffer runs out of voice data to play because the next voice packet has not arrived, but the consequences of the jitter are normally reduced by a jitter buffer located in the receiving terminal. A jitter buffer, or a de-jittering buffer, adds a variable extra delay before the audio samples of the packet are played out, to keep the overall delay time constant, or slowly varying, in order to minimize the overall delay at some given packet loss rate depending on the current network conditions. Thereby, the occurrence of buffer underrun due to delay jitter may be avoided, but the overall delay will be increased.

The term IP-packet, or packet, is hereinafter defined as a unit of data at the IP-level, the data comprising IP-payload and a header. The IP-payload may contain a UDP-packet, containing a UDP-payload and a UDP-header, and the UDP-payload may contain an RTP-packet, comprising an RTP-payload and an RTP-header. Thus, in VoIP, each IP-packet will contain headers from the protocols used, e.g. IP, UDP and RTP, as well as an RTP-payload containing one or more groups of audio samples, each group of samples hereinafter defined as an audio frame. In AMR-NB/WB, (Adaptive Multi Rate-Narrow Band/Wide Band), each audio frame contains 20 ms of audio samples, corresponding to 160 audio samples in AMR-NB and 320 audio samples in AMR-WB, due to different sampling frequencies. The number of samples in an audio frame is hereinafter defined as the audio frame length.

The sampling frequency for AMR-NB is specified to 8000, i.e. the voice signal is sampled 8000 times/sec, and since each 160 samples are grouped in one audio frame, 50 audio frames will be generated for transmission each second. If only one audio frame is transmitted in each packet, the packets will be transmitted at a packet rate of 50 packets/sec, and if two audio frames are aggregated in each packet, the packets will be transmitted at a packet rate of 25 packets/second.

If only one audio frame is transmitted in each packet, then the time stamp of this audio frame corresponds to the RTP presentation time stamp for the received packet, to be found in the RTP header of the packet. However, if the packet contains more than one audio frame, then the time stamp of the consecutive audio frames may be calculated by adding the appropriate number of audio frame lengths to the RTP packet time stamp.

The audio samples are compressed by an AMR-encoder for transport in the RTP payload of the IP packet and decoded after the reception, when the speech signal is reconstructed. An aggregation of more than one audio frame in one IP-packet will result in a packetization delay, since the transport of the IP-packet will be delayed until all the audio frames are encoded. Therefore, it is advantageous to send only one audio frame in a IP-packet.

Thus, a packet-switched transport network inherently causes variations in the transmission delay, and a real-time service, like VoIP, requires both a low delay and an interruption free play-out. As described above, the audio frames of a received packet are conventionally stored in a jitter buffer in order to delay the play-out to compensate for delay variations in the transport, and if the audio frames are delayed long enough to allow the audio frame with the highest transport delay to arrive before its scheduled play-out time, the receiving terminal will be able to make a proper reconstruction of the speech signal.

The jitter may be described as a distortion of the inter-packet time, i.e. the time interval between the received packets, as compared to the inter-packet time of the original signal transmission, and de-jittering for VoIP applications should be designed in such a way that the play-out is delayed long enough to allow most of the audio frames to arrive in time. The play-out delay could be reduced as long as the late audio frames, arriving after the scheduled play-out time, do not jeopardize the speech quality.

FIG. 1 illustrates the transmission of packetized speech 10 in an IP-network 12, showing a jitter buffer 14 located before a play-out buffer 16, and the receiving terminal will be able to make a proper reconstruction of the signal if the play-out is delayed in the jitter buffer to compensate for the delay variations in the transport. The delay variations after transmission through an IP-network 12 is illustrated in the figure by the Bytes/Time-diagrams associated with A, B and C, respectively. The Bytes/Time-diagram associated with A illustrates the transmitted speech, the Bytes/Time-diagram associated with B illustrates the distorted speech received after the transmission through the IP-network 12, and the Bytes/Time-diagram in C illustrates the speech after the delaying jitter buffer 14. Thus, the Bytes/Time-diagram associated with B illustrates the delay jitter introduced by the transmission through the IP network, and the Bytes/Time diagram associated with C illustrates the received speech signal after the jitter compensation in the jitter buffer 14.

The time an audio frame spends in the jitter buffer depends on the actual transmission delay and the current play-out delay, and the audio frames in the jitter buffer may be consumed faster or slower than the nominal play-out rate in order to adjust the play-out delay. An important part of jitter buffer management for VoIP is to control the jitter buffer in such a way that it is constantly striving for an optimal play-out delay based on a prediction of the coming jitter. Such predictions may be based on both the current jitter as well as historical jitter measurements, or by using late audio frames as an indication that the play-out delay has to be increased.

Thus, exemplary conventional technical solutions to measure jitter for VoIP applications are based e.g. on measurements of the packet spacing, i.e. the inter-packet time, or on the difference between an expected and actual packet arrival time. It is also possible to estimate jitter if the transmission delay is known.

In the FIGS. 2a, 2b and 2c, only one audio frame is contained in each packet. FIG. 2a illustrates the inter-packet time, i.e. packet spacing, before transmission of the audio frames, i.e. the time intervals between the transmission of consecutive audio frames. If the audio frames are transmitted with a time interval of e.g. 20 ms, the speech samples of each audio frame, e.g. 160 samples, will be transmitted on 20 ms, since the speech is transmitted as a continuous stream of audio samples. Thus, the inter-packet times 21a, 21b, 21c are equal before the transmission, and will correspond to the transmission time of the samples of an audio frame, i.e. to the audio frame length 24. Due to the jitter, the actual inter-packet time after the transmission may differ from the inter-packet time before the transmission, which is illustrated in the FIGS. 2b and 2c.

In FIG. 2b, the actual inter-packet time (packet spacing) after the transmission, i.e. the time intervals between the arrival of consecutive packets/audio frames, are indicated by 22a, 22b, and 22c.

In FIG. 2c, the difference between the expected arrival time and the actual arrival time for consecutive packets/audio frames are indicated by 23a, 23b and 23c.

Conventionally, the jitter may be calculated based on the actual packet spacing, i.e. the inter-packet time, or on the expected arrival time.

Jitter calculated based on the inter-packet time may be referred to as inter-arrival time jitter, which is hereinafter defined as the actual inter-packet time 22a, 22b, 22c after the transmission, compared to the expected inter-packet time, the expected inter-packet time corresponding to the inter-packet time 21a, 21b, 21c before the transmission and to the audio frame length 24. More specifically, the inter-arrival time jitter, Jitter[k,k−1], may be defined according to the following algorithm, expressed in a number of samples:

Jitter[k,k−1]=(arrival_time[k]−arrival_time[k−1])×sample_freq−audio frame_length×no_of_audio_frames_in_each_packet

In the above algorithm, as well as in the next, the “k”-index refers to the packets in the sequence that they are received. If one packet contains only one audio frame, the expected inter-packet time will correspond to the audio frame length 24, and the minimum jitter may never be smaller that this. For AMR-NB (Adaptive Multi Rate-Narrow Band), in which one packet comprises only one audio frame containing 160 samples, corresponding to 20 msec, the minimum jitter, as calculated from the algorithm above, will correspond to the audio frame length, e.g. −160 samples. A jitter with a value below zero indicates that a packet has arrived too early, and the minimum jitter will occur when a packet is received at the same time as the previously transmitted packet. If packets are transmitted with an interval of 20 ms, corresponding to 160 samples, then the minimum jitter will occur when a packet is received at the same time as the previously transmitted packet, and the minimum jitter will be −160 samples, if a packet contains only one audio frame.

Jitter calculated based on the expected arrival time for a packet may use a fixed reference point together with an RTP presentation time stamp of the packet, expressed in a number of samples, in order to find an expected arrival time.

If the first packet is the reference, the jitter, Jitter[k, 1], may be expressed according to the following algorithm, the jitter expressed in a number of samples:

Jitter[k,1]=(arrival_time[k]−arrival_time[1])×sample_freq−(time_stamp[k]−time_stamp[1])

Alternatively, conventional jitter measurement may use known transmission delays, with a receiver estimating the play-out delay as the difference between the maximum and the minimum transmission delay. However, this method can only be used if the transmission delays are known.

The above-described conventional method to use the inter-packet time for the jitter measurements, i.e. the measure the inter-arrival time jitter, is easy to perform but difficult to use. A VoIP client that wishes to maintain a certain level of late audio frames, i.e. a certain loss rate, e.g. not more than 0.5%, must be able to quantify the measured jitter into a number of audio frames needed in the buffer, which is not possible for inter-arrival time jitter. Inter-arrival time jitter can be measured on the IP/UDP (Internet Protocol/User Datagram Protocol)-level without any media specific information, as long as the media packets are encoded with a certain period. In practice, different segments of the signal are encoded differently, and, therefore, the RTP time stamps must be used.

Further, conventional jitter measurement methods may use a fixed reference point, and by measuring the jitter for each packet, it will be possible to find a play-out delay that achieves a certain level of late packets, i.e. loss rate. However, the fixed reference point requires that all old jitter measurements are re-calculated if the reference point is changed during a session, and in order to re-calculate jitter, data from previously received packets must be stored at the receiver.

Further, a sender and a receiver use different clocks for controlling the sampling frequencies of the encoding/decoding process, and since these clocks are not synchronized to each other, a small difference in local clock frequencies, i.e. a clock skew, will accumulate over time, and may result in systematic overruns or underruns of the jitter buffer. If the time difference between the last received packet and the packet used as a reference is too large, there is a risk that the clock skew may cause an incorrect estimation of the play-out delay. Jitter buffer management using this method to estimate jitter does not need to quantify the play-out delay into a number of audio frames needed in the jitter buffer, since a probability distribution function of the jitter measurements can be used to decide how to change the play-out delay. However, this method may be too slow in adapting to a decreasing delay, since it will take some time before a lower delay will have an effect on the statistics in such way that the play-out delay is decreased.

Thus, the above described conventional methods of estimation jitter have various drawbacks.

### SUMMARY

The object of the present invention is to address the problem outlined above, and this object and others are achieved by the method in a receiving terminal and by a receiving terminal, according to the appended independent claims, and by the embodiments according to the dependent claims.

According to a first aspect, the invention provides a method in a receiving terminal of estimating a required jitter buffer depth for a received audio frame of an IP-packet, by the steps of locating the previously received audio frame transmitted with the lowest transmission delay, which is the fastest audio frame; calculating an estimated required play-out delay for said received audio frame using stored data associated with said located fastest previously received audio frame; and transforming said estimated required play-out delay into a required jitter buffer depth.

According to a second aspect, the invention provides a method in a receiving terminal of jitter buffer management, by estimating the required jitter buffer depth for each audio frame when an IP-packet is received, according to the first aspect of this invention.

According to a third aspect, the invention provides a receiving terminal comprising a jitter buffer, a play-out unit, and an arrangement for estimating a required jitter buffer depth for a received audio frame of an IP packet. Said arrangement comprises means for locating the previously received audio frame transmitted with the lowest transmission delay, which is the fastest audio frame; means for calculating an estimated required play-out delay for said received audio frame using stored data associated with said located fastest previously received audio frame; and means for transforming said calculated estimated required play-out delay into a required buffer depth.

It is an advantage of the present invention that a required jitter buffer size can be estimated without knowledge of the actual transmission delay. Further, the present invention enables a precise and reliable estimation of the required number of audio frames needed in a jitter buffer to achieve a certain loss rate, i.e. late audio frame rate, and the clock skew between a sender and a receiver will only have a small impact on the estimation. Additionally, the low complexity and memory requirements make this invention easy to introduce in a mobile terminal.

### BRIEF DESCRIPTION OF THE DRAWINGS

The present invention will now be described in more detail, and with reference to the accompanying drawings, in which:

FIG. 1 is a block diagram illustrating how speech packets are forwarded over an IP network, to a jitter buffer and a play-out unit of a receiving terminal (not illustrated);

The FIGS. 2a, 2b and 2c illustrates the inter-packet time before and after transmission;

FIG. 3 is a flow diagram schematically illustrating a method of jitter buffer management, according to en embodiment of this invention;

FIG. 4 illustrates the transmission delay of four previously received audio frames with indexes 0, 1, 2, and 3, a larger diff[i] indicating a lower transmission delay, i.e. a faster audio frame.

FIG. 5 illustrates a play-out unit, which receives audio frames from a jitter buffer;

FIG. 6 is a flow diagram illustrating a first embodiment of the method of estimating a required jitter buffer depth for a received audio frame, according to this invention;

FIG. 7 is a flow diagram illustrating further embodiments of the method in FIG. 6;

FIG. 8a illustrates the relation between the arrival time or the fastest previous audio frame and the play-out time, according to the further embodiments of the estimation method;

FIG. 8b illustrates the relation between the arrival time of an audio frame, the earliest play-out time, and the margin;

FIG. 9 illustrates an RTP packet containing n audio frames;

FIG. 10 is a block diagram illustrating a receiving terminal provided with a jitter buffer, a play-out unit and jitter buffer management unit, according to this invention;

FIG. 11 is a flow diagram illustrating jitter buffer management comprising the jitter buffer depth estimation according to this invention, and

FIG. 12 is a histogram illustrating an exemplary jitter buffer management.

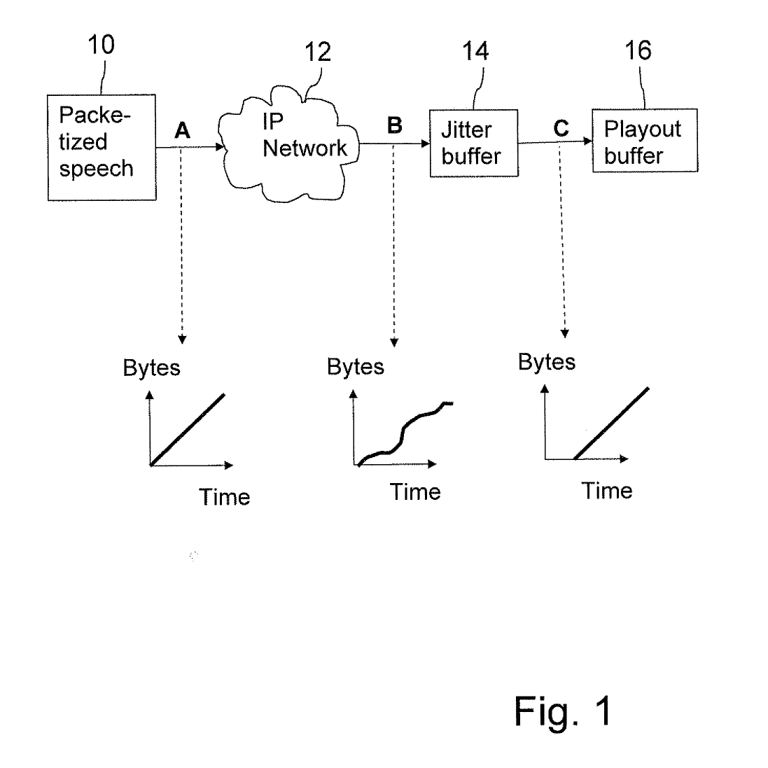

### DETAILED DESCRIPTION

In the following description, specific details are set forth, such as a particular architecture and sequences of steps in order to provide a thorough understanding of the present invention. However, it is apparent to a person skilled in the art that the present invention may be practised in other embodiments that may depart from these specific details.

Moreover, it is apparent that the described functions may be implemented using software functioning in conjunction with a programmed microprocessor or a general purpose computer, and/or using an application-specific integrated circuit. Where the invention is described in the form of a method, the invention may also be embodied in a computer program product, as well as in a system comprising a computer processor and a memory, wherein the memory in encoded with one or more programs that may perform the described functions.

The following abbreviations will be used hereinafter in this specification:

### VoIP: Voice Over Internet Protocol

### IP/UDP: Internet Protocol/User Datagram Protocol

### AMR-NB: Adaptive Multi Rate-Narrow Band

### PSTN: Public Switched Telephony Network

### RTP: Real-time Transport Protocol

### IMS: Internet Protocol Multimedia Subsystem

Additionally, the following definitions will be used hereinafter:

The arrival_time[i]: The arrival time of audio frame “i” (timestamp, expressed in number of samples, depends on the sampling frequency.

The arrival_time_sec[i]: The arrival time of audio frame “i” (seconds).

The earliest_play-out_time[i]: The earliest point of time when an audio frame may be played out. To calculate this, the ongoing play-out and the play-out_period must be considered.

The audio frame length: The audio frame_length, indicated in no. of samples, depends on the sampling frequency.

The max_audio frames_in_buffer: The maximum number of audio frames in the jitter buffer that are needed to handle the play-out delay for the last received audio frame (play-out_delay[0]). The number of audio frames in the jitter buffer is counted just before an audio frame is extracted.

The max_index: Index to the audio frame with the lowest transmission delay, i.e. the fastest audio frame.

The play-out_delay[i]: The play-out delay for the audio frame “i”.

The play-out_period: The periodicity with which data is fetched from the audio buffer (timestamp), which depends on the actual implementation.

The play-out_time[i]: The play-out time for audio frame “i”

The play-out_timestamp[last_played_audio frame]: The RTP time stamp for the last played audio frame.

The sample_freq: The sampling frequency for the audio samples.

The time_stamp[i]: The RTP time stamp for the audio frame “i”.

The basic concept of this invention relates to an estimation of the minimum play-out delay that is needed in order to handle variable transmission delays, i.e. jitter, for received audio frames in a packet-switched network, and the minimum play-out delay is expressed as the required number of audio frames in a jitter buffer, i.e. the required jitter buffer depth.

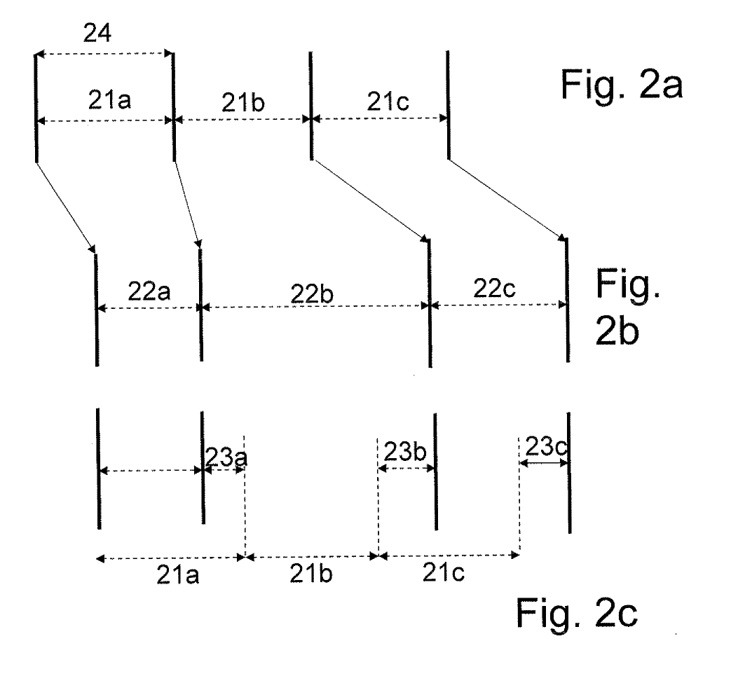

FIG. 3 is a flow diagram illustrating an exemplary jitter buffer management, involving said jitter buffer depth estimation, according to this invention. In step 31, a media packet delivered from a network interface arrives to a receiving terminal. In step 32, the RTP payload is de-packetized, and all the received audio frames are stored in a jitter buffer, together with data related to each frame, i.e. the arrival time and the RTP time stamp. If multiple audio frames are delivered in the RTP packet, then the time stamp for each audio frame is calculated by an addition of the appropriate number of audio frame lengths to the RTP time stamp. Further, in case of multiple audio frames, adjustments are preferably made to exclude the packetization delay, in step 33, by calculating an new adjusted arrival time[j], for each audio frame in a packet with n audio frames, expressed in no. of samples, e.g. according to the following algorithm:

Adjusted_arrival_time[j]=arrival_time[j]−(time_stamp[n]−time_stamp[j]),

in which j=1 to n, 1 indicating the first audio frame in a packet and n indicating the last audio frame.

The following steps 34-37 are repeated for each audio frame in a received packet: The information stored in the receiving terminal is used to estimate the required jitter buffer depth for a received audio frame, in step 34, and the estimated jitter buffer depth is made available for jitter buffer management, in step 35. The information required for the next estimation is stored, in step 36, and in step 37 it is determined whether the packet contains any more audio frames. If not, then the steps 34-37 are repeated until the estimation has been performed for all the audio frames of the received packet.

However, this invention is not primarily directed to a complete method for jitter buffer management, only to an estimation of the play-out delay, transformed into a required jitter buffer depth, which is an important part of jitter buffer management. Thus, the core of this invention corresponds to the steps 34 and 36 in FIG. 3, and these steps will be described more thoroughly as follows:

If a received IP packet comprises more than one audio frame, then the arrival time in the algorithms hereinafter may correspond to a new adjusted arrival time, calculated according to the algorithm above, in order to exclude the packetization delay.

In step 34 in FIG. 3, the play-out delay is estimated for the current audio frame, i.e. the last received audio frame, by using stored information from previously received audio frames, preferably up to 40 audio frames. The first part of step 34 involves finding the index of the audio frame having the lowest transmission delay (max_index) among the previously received and stored audio frames, by going through a list storing information about the received audio frames, and comparing each audio frame's arrival time with its presentation time. The previously received audio frame with the lowest transmission delay is the fastest audio frame, and will, therefore, spend more time in the jitter buffer. To be able to make a comparison between the last received audio frame and the fastest audio frame, the same time unit has to be used, e.g. by converting the arrival time, which is given in seconds, to a number of samples by multiplying the arrival time with the sampling frequency. The arrival time is then comparable with the presentation time, since both are using RTP time stamp units. The index “i” indicates the audio frame index in the data storage, and the range for the audio frame index is e.g. between 0 and 40. The index “i”=0 represents the last received audio frame, i.e. the current audio frame, which is also the audio frame for which the play-out delay is calculated. Initially, fewer audio frames have to be used, until 40 audio frames have been received.

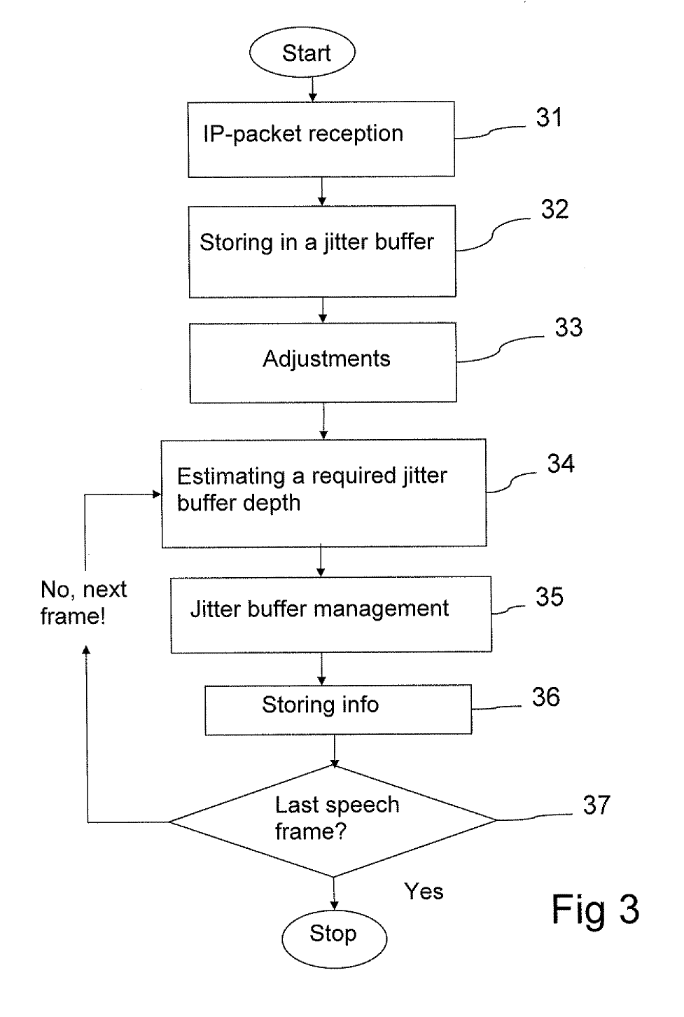

FIG. 4 illustrates the time stamps of the presentation time and the audio frame arrival time for the four audio frames numbered from 0 to 3, as well as diff[i]. Audio frame 0 is the last received audio frame, and the arrival time, arrival time[i], is defined according to the following algorithm, expressed in a number of samples:

arrival_time[i]=arrival_time_sec[i]×sample_freq

It must be ensured that time_stamp[i]>arrival_time[i] for i=0 to 40 by adding/subtracting a constant value from either the time stamp or the arrival time. The difference, diff[i], may be calculated by the following algorithm:

diff[i]=time_stamp[i]−arrival_time[i]

Thus, the index for the audio frame with the lowest transmission delay, i.e. the fastest audio frame, can be located from the stored data, and the max_index is the index that maximizes diff[i] for i=0 to 40. In FIG. 4, the max_index will correspond to 3, which represents the fastest audio frame.

The next step is to calculate the play-out delay, expressed in samples, for the last received audio frame, i.e. the current audio frame, by using the audio frame with the lowest transmission delay, i.e. the fastest audio frame, as a reference point. If the last received audio frame is played immediately, the audio frame with the lowest transmission delay should be delayed by the jitter buffer according to the calculated play-out delay. In step 34 in FIG. 3, the play-out delay in samples for the last received audio frame, the play-out_delay[0], is estimated e.g. by determining the arrival time difference between the last received audio frame and the fastest audio frame, and by determining the difference between said arrival time difference and the time stamp difference between said last received audio frame and the fastest audio frame, which may be expressed by the following algorithm, expressed in a number of samples:

play-out_delay[0]=(arrival_time[0]−arrival_time [max_index])−(time_stamp[0]−time_stamp[max_index])

According to this invention, the estimated play-out delay in samples is quantified in the number of audio frames needed in the jitter buffer to accommodate the estimated play-out delay, max_audio frames_in_buffer, i.e. the required jitter buffer depth. This may be performed by determining the relationship between the estimated play-out delay in samples and the number of samples in the audio frame, e.g. according to the following algorithm:

max_audio frames_in_buffer=1+ceil(play-out_delay[0]/audio frame_length)

The ceil(x) rounds x to the nearest integer towards infinity, i.e. if the play-out delay is 161 samples and the audio frame_length is 160 samples, then ceil(161/160) will be 2; otherwise the audio frames will not be accommodated in the jitter buffer. Since the number of audio frames in the jitter buffer is counted just before a audio frame is extracted, a number 1 (one) has to be added in calculating the max_audio frames_in_buffer.

To be able to make this estimation, information regarding previously received audio frames must be available. This information is stored in step 36 in FIG. 3, and the information contains data associated with the last received audio frame, e.g. the arrival time, the RTP (Real-time Transport Protocol) time stamp, which may be calculated for each audio frame in a packet containing more than one audio frame by adding the appropriate number of audio frame_lengths to the RTP packet time stamp, and the RTP sequence number. The information may also include data regarding the current play-out state, the play-out time for the last played audio frame, and the RTP time stamp for the last played audio frame, which could be used for estimating the play-out delay, according to further embodiments of this invention, in which a more precise estimation is obtained.

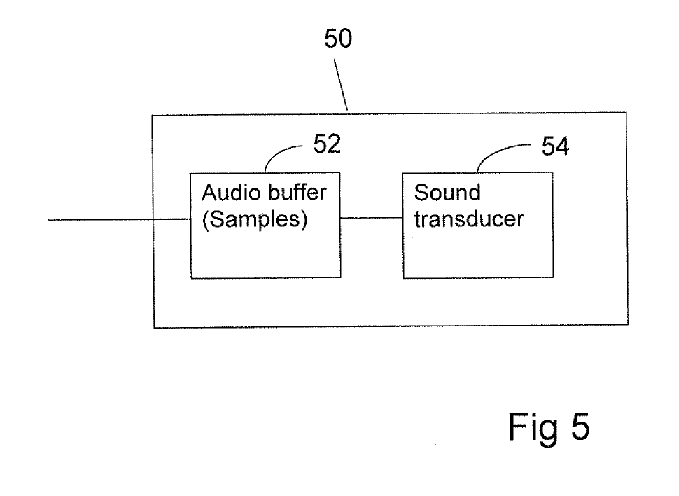

FIG. 6 is a flow diagram illustrating the basic concept of this invention, i.e. how to estimate the required jitter buffer depth for a received audio frame, corresponding to step 34 in the above-described FIG. 3. In step 61 in FIG. 6, the previously received audio frame with the lowest transmission delay is located, i.e. the fastest audio frame, using stored information. In step 62, the play-out delay for a received audio frame is calculated, using data of the received audio frame and of said located fastest audio frame, e.g. the arrival time and the time stamps of said audio frames, as described above. In step 63, the play-out delay is transformed into a required jitter buffer depth, indicating the number of audio frames needed in the jitter buffer to accommodate the estimated play-out delay, and this transformation may e.g. be performed as described above, by determining the relationship between the estimated play-out delay in samples and the number of samples in the received audio frame.

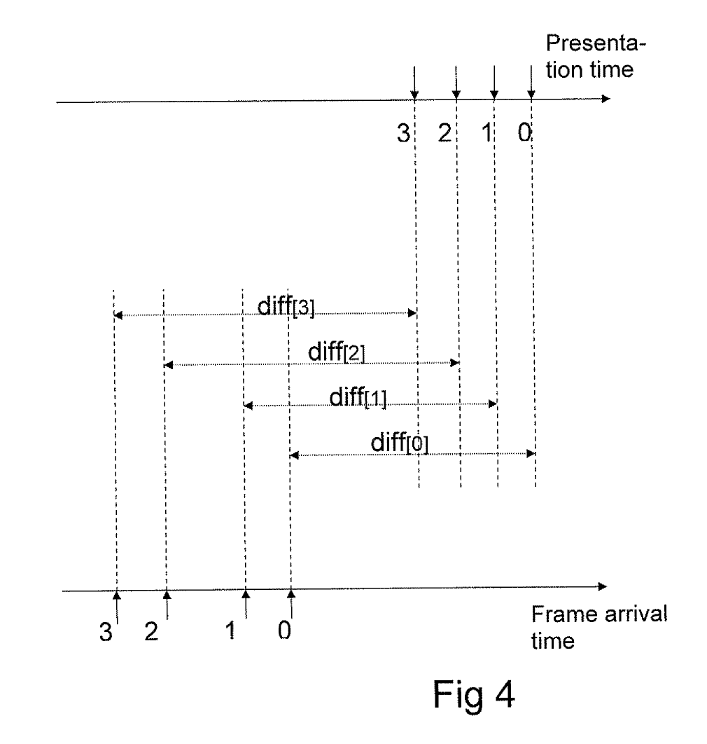

In FIG. 5, a jitter buffer (not illustrated in the figure) is connected to a play-out unit 50, which comprises an audio buffer 52 and a sound transducer 54. The jitter buffer of a receiving terminal is normally connected to the audio buffer 52 in the play-out unit 50. The sound transducer 54 fetches samples from the audio buffer 52 regularly, and this period is specified as the play-out_period. If the audio buffer is empty, an audio frame is fetched from the jitter buffer, decoded and stored in the audio buffer, from which data may be fetched by the sound transducer 54, e.g. with a play-out period of 20 msec. The length, expressed in a number of samples, of an audio frame is codec-dependent and must be specified in the audio frame_length, and the AMR-NB (Adaptive Multi Rate-Narrow Band) audio frame_length is 160 samples, corresponding to 20 msec.

According to this invention, a play-out delay is estimated in samples and transformed into a required jitter buffer depth expressed in a number of audio frames, which is adapted for jitter buffer management. According to a further embodiment of this invention, the current play-out state is also considered in the estimation of the play-out delay, or in the transformation of the play-out delay to a required buffer depth.

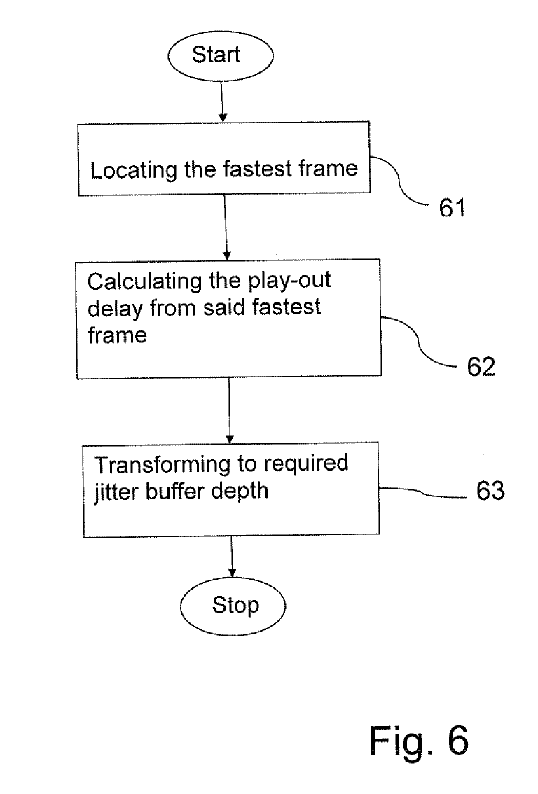

FIG. 7 illustrates how the play-out delay is calculated and quantified depending on the different play-out states, as indicated by Case 1, Case 2 and Case 3.

The play-out delay calculated according to Case 1, in step 75, relates to a play-out state in which play-out is not ongoing, or when it is acceptable with a predicted play-out delay up to 20 msec higher than the required delay, which is determined in step 70. According to Case 1, the play-out delay in samples for audio frame[0], i.e. play-out_delay[0], is calculated e.g. by the following algorithm, which is also described above:

play-out_delay[0]=(arrival_time[0]−arrival_time[max_index])−(time_stamp[0]−time_stamp[max_index])

Thereafter, this estimated play-out delay may be quantified in a maximum number of audio frames needed in the jitter buffer, the max_audio frames_in_buffer, i.e. the required buffer depth, e.g. by the following algorithm, which is also described above:

max_audio frames_in_buffer=1+ceil(play-out_delay[0]/audio frame_length)

The ceil(x) rounds x to the nearest integer towards infinity. Since the number of audio frames in the jitter buffer is counted just before a audio frame is extracted, a number 1 (one) has to be added in calculating the max_audio frames_in_buffer.

The play-out delay calculated according to Case 2, in step 74, relates to a play-out state when the play-out is ongoing when the fastest audio frame, audio frame[max_index], arrives, but not when the current audio frame, audio frame[0], arrives, as determined in step 73. The play-out delay for audio frame[0], expressed in a number of samples, is calculated e.g. by the following algorithm:

play-out_delay[0]=(arrival_time[0]−earliest_play-out_time[max_index])−(time_stamp[0]−time_stamp[max_index])

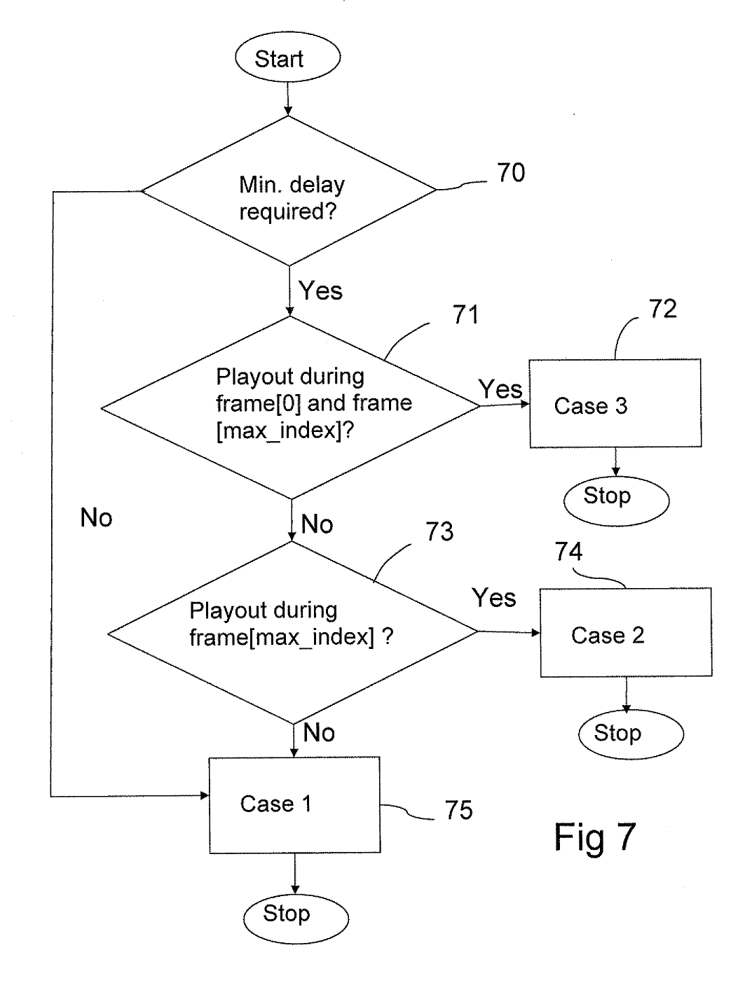

The earliest play-out_time[max_index] depends on when data is fetched from the jitter buffer. FIG. 8a illustrates data fetched from the jitter buffer for play-out at the time instances indicated by 80a, 80b, 80c and 80d, and the play-out period 81 may be e.g. 20 msec. The arrival time for the fastest audio frame, arrival_time[max_index], is indicated by 82, and the earliest play-out time for said fastest audio frame, earliest_play-out_time[max_index], corresponds to the time instance indicated by 80b. Thus, FIG. 8a illustrates the relation between the arrival_time[max_index] and the play-out time, and the maximum distance between the arrival_time[max_index] 82 and the earliest_play-out_time[max_index]80b will be shorter than the play-out_period 81.

Thereafter, the estimated play-out delay may be quantified in a maximum number of audio frames required in the jitter buffer, i.e. the required buffer depth, according to the same algorithms used in Case 1:

max_audio frames_in_buffer=1+ceil(play-out_delay[0]/audio frame_length)

The play-out delay calculated according to Case 3, in step 72, relates to when the play-out is ongoing both when the current and the fastest previous audio frame arrive, i.e. audio frame[0] and audio frame[max_index], as determined in step 71. According to case 3, the play-out_delay[0] is calculated similarly as in case 2 described above, but a margin is calculated before transforming the play-out_delay[0] to the required jitter buffer depth. The margin is illustrated in FIG. 8b, and may be calculated according to the following algorithm, expressed in a number of samples:

margin=ceil(play-out_delay[0]/audio frame_length)×audio frame_length−play-out_delay[0]

FIG. 8b illustrates the relation between the arrival time of the last (current) audio frame, i.e. the arrival_time[0], indicated by 83, and the earliest play-out of said current audio frame, i.e. the earliest_play-out_time[0] of said audio frame, indicated by 80b, and said margin 84. The estimated play-out delay, expressed in samples, is transformed into a number of audio frames needed in the jitter buffer, i.e. the buffer depth. If the earliest play-out time 80b of the current audio frame occurs within said margin 84, i.e. if the earliest_play-out_time[0]<arrival_time[0]+margin), then the jitter buffer depth may be calculated according to the following algorithm:

max_audio frames_in_buffer=1+floor(play-out_delay[0]/audio frame_length),

in which floor(x) rounds x to the nearest integer towards minus infinity.

However, if the earliest play-out time 80b of the current audio frame is not within the margin 84, i.e. if the earliest_play-out_time[0]≧arrival_time[0]+margin), then the jitter buffer depth may be calculated according to the following algorithm:

max_audio frames_in_buffer=1+ceil(play-out_delay[0]/audio frame_length),

in which ceil(x) rounds x to the nearest integer towards the infinity.

Since the number of audio frames in the jitter buffer is counted just before a audio frame is extracted, a number 1 (one) has to be added in calculating the max_audio frames_in_buffer, according to the algorithms above.

Thus, the play-out delay estimation, as described above, uses the received audio frames arrival time and RTP time stamps. If multiple audio frames are contained in each received IP packet, then the time stamps for each frame is calculated by adding one extra audio frame length to the RTP packet time stamp for each received audio frame.

Further, if an audio frame aggregation indicates that multiple audio frames are delivered in the same RTP packet, the first audio frame in the packet has to wait until the last audio frame in the packet has been encoded before the packet can be transmitted. This is called packetization delay, and should preferably not influence the play-out delay estimation. Therefore, according to a further embodiment of the method of jitter buffer management, according to this invention, the arrival time for the audio frames in the last received packet is adjusted to exclude the packetization delay. This adjustment is illustrated in step 33 in FIG. 3, and described above in connection with this figure. The new adjusted arrival time, adjusted arrival time[j], for a packet with n audio frames may be calculated e.g. according to the following algorithm, which is previously described in connection with FIG. 3:

Adjusted_arrival_time[j]=arrival_time[j]−(time_stamp[n]−time_stamp[j]),

in which j=1 to n, 1 indicating the first audio frame in a packet and n indicating the last audio frame.

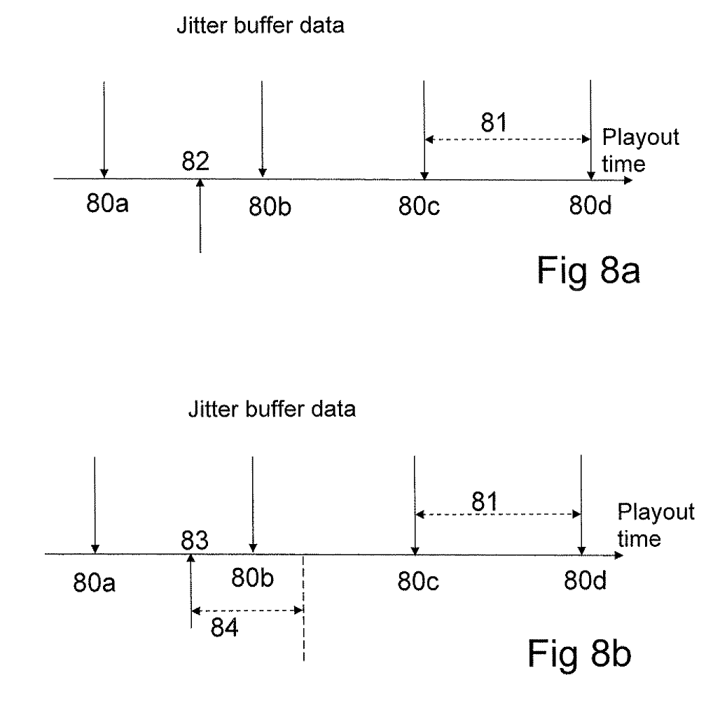

FIG. 9 illustrates a RTP packet 92 containing n audio speech audio frames 94. In a packet 92 containing more than one audio frame 94, the time stamp of each consecutive audio frame may be calculated, as described above, by adding the appropriate number of audio frame_lengths (in number of samples) to the RTP presentation time stamp of the RTP header in the packet 92.

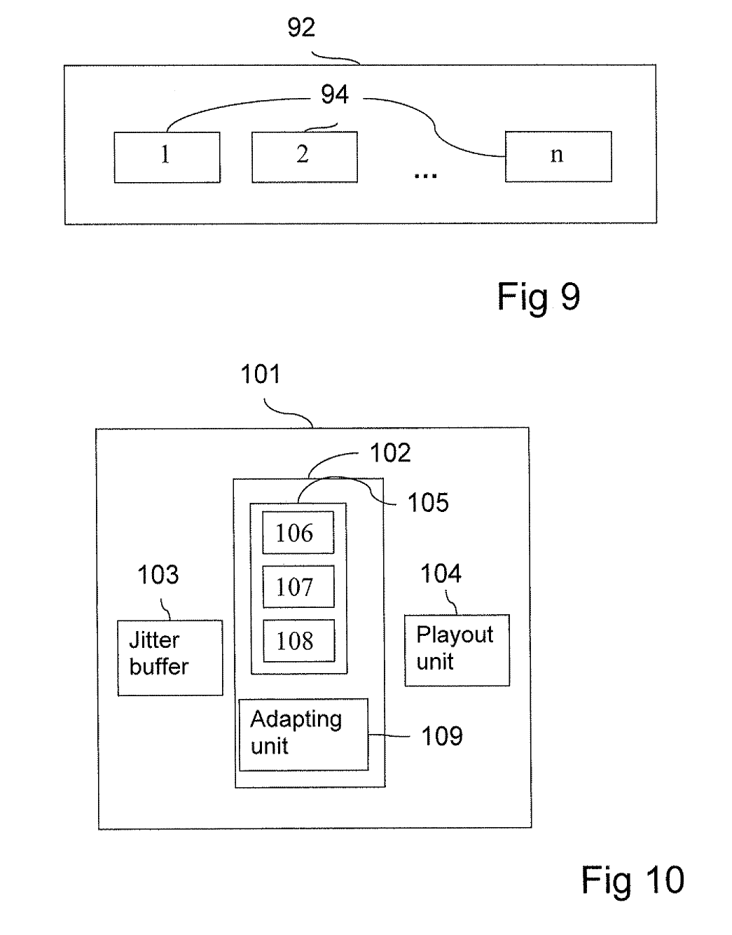

FIG. 10 shows an exemplary embodiment of a receiving terminal 101 according to this invention. The receiving terminal is typically a user terminal, such as e.g. an IP phone, but the receiving terminal may alternatively be any client terminal arranged to receive IP-packets, such as e.g. a Gateway between an IP-network and a PSTN (Public Switched Telephony Network). The receiving terminal is provided with a jitter buffer 103 and a play-out unit 104, as well as with a jitter buffer manager 102, which comprises an arrangement 105 for estimating a required jitter buffer depth, according to this invention. This arrangement 105 further comprises means 106 for locating the previously received fastest audio frame, means 107 for calculating a the estimated play-out delay, in samples, for a received audio frame, and means 108 for transforming said estimated play-out delay into a the required size of the jitter buffer in order to accommodate the estimated play-out delay.

According to a preferred embodiment, said means 107 for calculating an estimated play-out delay is arranged to determine an arrival time difference between the last received audio frame and the fastest audio frame, and to further determine the difference between said arrival time difference and a time stamp difference between the last received audio frame and the fastest audio frame. Said means 108 for transforming the estimated play-out delay into a required size of the jitter buffer is preferably arranged to determine the relationship between the number of samples of the estimated play-out delay and the number of samples in the audio frame.

According to other embodiments of the invention, the means 107 for calculating an estimated play-out delay and the means 108 for transforming the estimated play-out delay into a jitter buffer size is arranged to consider the play-out state, such that if the play-out is ongoing when at least the fastest audio frame arrives, said means 107 for calculating will determine said arrival time difference as the difference between the arrival time of last received audio frame and the earliest play-out time of the fastest audio frame, instead of as the arrival time difference between the last received audio frame and the fastest audio frame.

Preferably, the jitter buffer manager 102 is also provided with an adapting unit 109 for adapting the play-out speed, e.g. by a time scaling technique, or by discarding or repeating a audio frame.

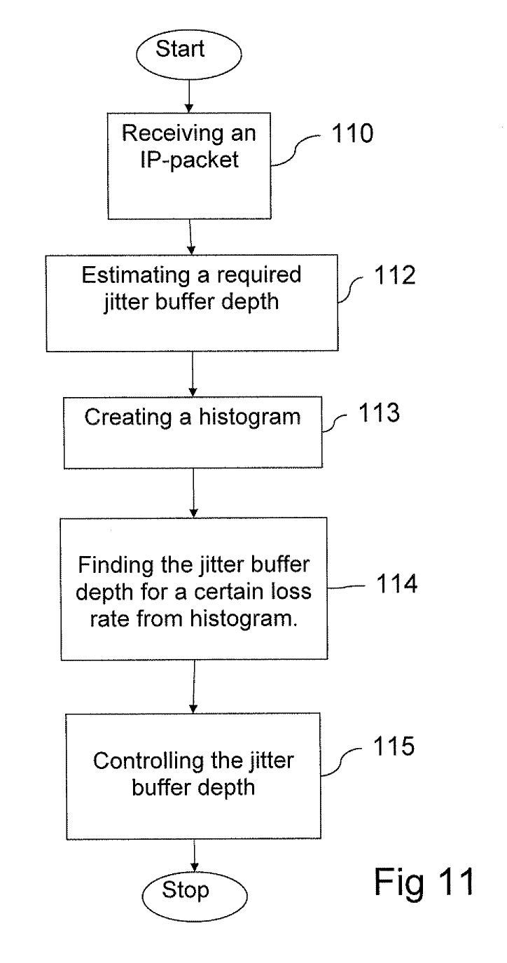

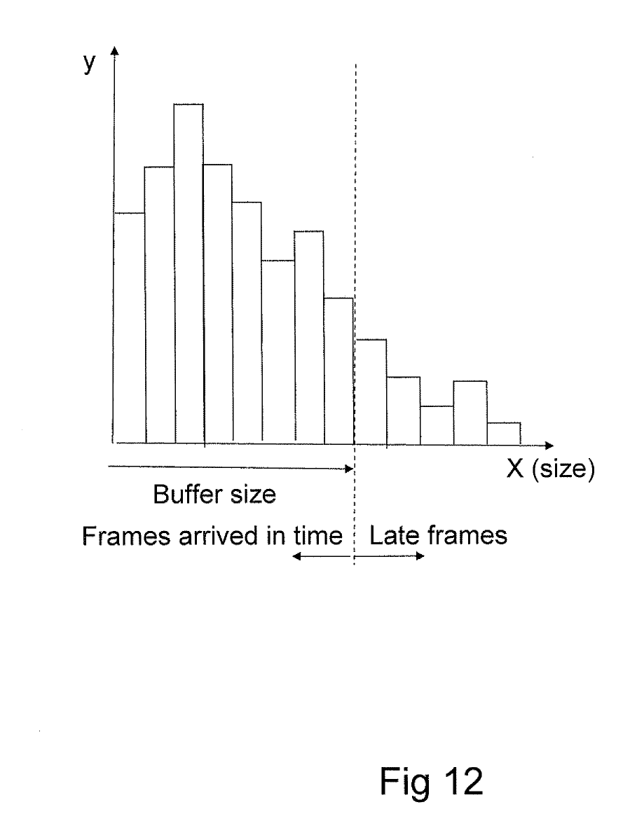

FIG. 11 illustrates an exemplary method of jitter buffer management comprising a jitter buffer depth estimation, according to this invention. In step 110 in FIG. 11, a packet is received from the network. In step 112, the number of audio frames required in the jitter buffer is estimated for each received audio frame, according to this invention. In step 113, a histogram of these estimates is created, and the histogram is illustrated in FIG. 12.

In FIG. 12, an estimated required size of a jitter buffer is illustrated on the x-axis, and the number of audio frames requiring this buffer size is indicated on the y-axis. Each bin of the histogram represents a speech audio frame, the later audio frames requiring a larger jitter buffer. According to this exemplary jitter buffer management, as illustrated in FIG. 11, the histogram is used to find the number of audio frames needed in the buffer to achieve a certain rate of late audio frames, i.e. loss rate, in step 114, a low loss rate requiring a larger size of the jitter buffer. The loss rate is illustrated in the histogram as the number of late audio frames divided by all of the audio frames. In step 115, the jitter buffer is controlled such that the maximum number of audio frames in the jitter buffer, i.e. the jitter buffer depth, corresponds to a value indicated by the hatched line in the histogram.

This invention has several advantages, e.g. to simplify for the jitter buffer management to fulfil the minimum performance requirement for IMS telephony specified in 3GPP TS 26.114, and to secure a good trade off between quality and delay, by implementing this invention in a VoIP client. Further, the invention provides means to manage a jitter buffer without any knowledge about the actual transmission delay, as well as enabling a precise and reliable estimation of the required number of audio frames needed in a jitter buffer to achieve a certain loss rate, i.e. late audio frame rate. The clock skew between a sender and a receiver will only have a small impact on the estimation, and according to a further embodiment of the invention, the client's play-out state is considered when the jitter buffer size is estimated in order to find the minimum size. Additionally, the low complexity and memory requirements make this invention easy to introduce in mobile terminals.

Since a common characteristic for wireless systems is the high intrinsic delay, and the end-to-end delay requirement for VoIP is the same regardless of the access technology, a wireless system has less time to perform de-jittering than wireline systems. By using this invention, the play-out delay in the jitter buffer can be minimised.

While the invention has been described with reference to specific exemplary embodiments, the description is in general only intended to illustrate the inventive concept and should not be taken as limiting the scope of the invention.

1-25. (canceled)

26. A method in a receiving terminal of estimating a required jitter buffer depth for a received audio frame of an IP-packet, the method comprising:
for each received audio frame, locating the fastest previously received audio frame by finding an index of the frame transmitted with the lowest transmission delay among a range of the last and previously received audio frames, using stored data;
calculating an estimated required play-out delay for said received audio frame using stored data associated with the received audio frame and with said located fastest previously received audio frame;
transforming said estimated required play-out delay into a required jitter buffer depth.

27. A method according to claim 26, wherein the step of calculating an estimated play-out delay comprises a determination of an arrival time difference between the received audio frame and the fastest previously received audio frame.

28. A method according to claim 27, wherein the step of calculating an estimated play-out delay further comprises a determination of the difference between said arrival time difference and a time stamp difference between the received audio frame and the fastest previously received audio frame.

29. A method according to claim 26, wherein the step of transforming said estimated play-out delay into a required jitter buffer depth comprises a determination of the relationship between the number of samples of the estimated play-out delay and the number of samples in the received audio frame.

30. A method according to claim 26, further comprising the step of storing the arrival time and the time stamp of each received audio frame.

31. A method according to claim 30, wherein the time stamp for the audio frames of a packet containing multiple audio frames is calculated by adding one additional audio frame length to the RTP packet time stamp for each received audio frame.

32. A method according to claim 26, wherein, if the play-out was ongoing when at least the fastest previously received audio frame arrived, then said arrival time difference in the step of calculating an estimated play-out delay is determined as the difference between the arrival time of the received audio frame and the earliest play-out time of said fastest previously received audio frame.

33. A method according to claim 26, wherein the current play-out state is considered in the transformation of the calculated estimated required play-out delay into a required jitter buffer depth.

34. A method according to claim 26, and further comprising performing jitter buffer management in the receiving terminal, based the required jitter buffer depth as estimated each audio frame when an IP-packet is received.

35. A method according to claim 34, further comprising the step of performing audio frame aggregation adjustments of a de-packetized IP packet containing multiple audio frames before estimating the required jitter buffer depth, in order to exclude the influence of the packetization delay.

36. A method according to claim 34, further comprising the step of creating a histogram representing the required jitter buffer depths, as estimated for received audio frames.

37. A method according to claim 36, further comprising the step of controlling the jitter buffer depth using the histogram, in order to achieve a certain audio frame loss rate.

38. A receiving terminal comprising a jitter buffer and a play-out unit, the receiving terminal including a jitter buffer depth estimating arrangement for estimating a required jitter buffer depth for a received audio frame of an IP packet, said arrangement comprising one or more processing circuits configured to:
locate the fastest previously received audio frame for each received frame, by finding an index of the frame transmitted with the lowest transmission delay among a range of the last and previously received audio frames, using stored data;
calculate an estimated required play-out delay for said received audio frame using stored data associated with the received audio frame and with said located fastest previously received audio frame; and
transform said estimated required play-out delay into a required buffer depth.

39. A receiving terminal according to claim 38, wherein the play-out unit comprises an audio buffer and a sound transducer, wherein the sound transducer is arranged to fetch data from the audio buffer with a pre-determined play-out period.

40. A receiving terminal according to claim 38, wherein the one or more processing circuits are configured to store the arrival time and the time stamp associated with the received audio frame.

41. A receiving terminal according to claim 38, wherein, in support of calculating the estimated required play-out delay, the one or more processing circuits are configured to determine an arrival time difference between the received audio frame and the located fastest previously received audio frame.

42. A receiving terminal according to claim 41, wherein, further in support of calculating the estimated required play-out delay, the one or more processing circuits are configured to determine the difference between said arrival time difference and a time stamp difference between the received audio frame and the located fastest previously received audio frame.

43. A receiving terminal according to claim 38, wherein, in support of transforming the estimated required play-out delay into the required jitter buffer depth, the one or more processing circuits are configured determine the relationship between the number of samples of the estimated require play-out delay and the number of samples in the received audio frame.

44. A receiving terminal, according to claim 38, wherein, in the case that the play-out was ongoing when at least said fastest previously received audio frame arrive, the one or more processing circuits are configured to determine the arrival time difference as the difference between the arrival time of the received audio frame and the earliest play-out time of the fastest previously received audio frame.

45. A receiving terminal according to claims 38, wherein the one or more processing circuits are configured to consider the play-out state in the transformation of the calculated play-out delay into the required jitter buffer depth.

46. A receiving terminal according to claim 38, wherein the one or more processing circuits are configured to perform jitter buffer management.

47. A receiving terminal according to claim 46, wherein, as part of performing jitter buffer management, the one or more processing circuits are configured to adapt the play-out speed.

48. A receiving terminal according to claim 46, wherein, as part of performing jitter buffer management, the one or more processing circuits are configured to perform audio frame aggregation adjustments of a de-packetized IP-packet containing multiple audio frames before estimating the required jitter buffer depth, in order to exclude the influence of the packetization delay.

49. A receiving terminal according to claim 46, wherein, as part of performing jitter buffer management, the one or more processing circuits are configured to create a histogram representing the estimated required jitter buffer depths for the received audio frames.

50. A receiving terminal according to claim 49, wherein the one or more processing circuits are configured to control the jitter buffer depth using the histogram, in order to achieve a certain audio frame loss rate.
